(19) United States
(12) Patent Application Publication
(10) Pub. No.: US 2015/0348278 A1
(43) Pub. Date: Dec. 3, 2015

(54) DYNAMIC FONT ENGINE

(71) Applicant: Apple Inc., Cupertino, CA (US)

(72) Inventors: Antonio Cavedoni, Cupertino, CA (US); Tung A. Tseung, Cupertino, CA (US); Julio A. Gonzalez, Cupertino, CA (US)

(73) Assignee: Apple Inc., Cupertino, CA (US)

(21) Appl. No.: 14/291,750

(22) Filed: May 30, 2014

(51) Int. Cl. G06T 7/20; G06T 11/00; G06T 3/40; G06T 11/60

(52) U.S. Cl. CPC G06T 7/20; G06T 11/60; G06T 11/001; G06T 3/40

(57) ABSTRACT

A method may include receiving a request to render text from an application executing on at least one processor of a computing device, the request including a font usage description; determining, using the at least one processor, a display context in which the text is to be rendered on a output device communicatively coupled to the computing device; querying, using the at least one processor, a usage data source using the determined display context and font usage description to determine font characteristics for rendering the text; and rendering the text on the output device communicatively coupled to the computing device using the determined font characteristics.

### TECHNICAL FIELD

Embodiments described herein generally relate to rendering text, and in particular, but not by way of limitation to a dynamic font engine.

### BACKGROUND

During application development, a programmer may specify characteristics of how text within an application is to be rendered. For example, a developer may specify one or more of a font face (e.g., Helvetica, Times New Roman), style (normal, italics, etc.), size, color, and spacing (between characters and between lines). During execution of the application, when the text is to be rendered, the application may retrieve a font file for the specified font and render the text with the specified characteristics.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram of a font usage request, according to an example embodiment;

FIG. 2 illustrates a schematic diagram of a determination of a dynamic font engine, according an example embodiment;

FIG. 3 illustrates is a schematic drawing illustrating rendering text using a dynamic font reference, according to an example embodiment;

FIG. 4 is a flow chart illustrating a method, in accordance with an example embodiment, to render text; and

FIG. 5 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present examples may be practiced without these specific details.

Application developers are often presented with a difficult choice when choosing fonts that are ultimately used on a diverse set of devices with different display characteristics and when the application itself is used in different contexts. For example, a certain font size may work well on a mobile phone, but look too small on a tablet screen with higher resolution and larger physical size. Similarly, a black font color may be viewable against a white background, but if the background color changes to something darker the text may become unreadable.

To address diverse use cases, application developers may choose to hard-code in a variety of font faces, sizes, colors, etc., for the different uses. However, even with hard-coding there may still be instances in which rendered text is unclear. Additionally developers often choose fonts that do not work well when actually output.

In various examples, a developer may use a font usage request when developing applications to help automatically determine a font and font characteristics for a given usage scenario. When the application executes, a dynamic font engine may choose a font face for the given usage scenario and text that is to be output. The dynamic font engine may also choose a size for text that is output. Additionally, the dynamic font engine may make typographical modifications to characters of the text before it is output. For example, the shape of a character may be modified (e.g., the outline interpolation or dilation) as well as layout spacing (tracking or kerning) and contrast. More detailed examples of the operations of a font usage request are described herein.

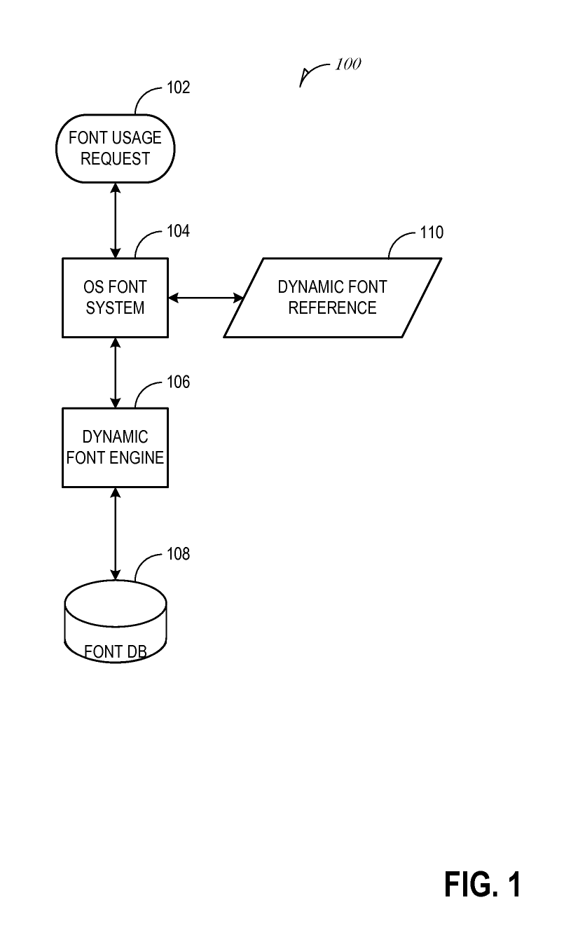

FIG. 1 is a schematic diagram 100 of a font usage request 102. The schematic diagram 100 also illustrates an operating system (OS) font system 104, a dynamic font engine 106, a font database 108, and a dynamic font reference 110.

In various examples, the components illustrated in the schematic diagram 100 are part of a computing device. A computing device may be, but is not limited to, a personal computer, a tablet computer, a mobile phone, a laptop computer, a printer, a projector, or a computer numerical control (CNC) computer. The computing device may include at least one processor (e.g., general purpose processor, processor core, virtual processor, or application-specific integrated circuit (ASIC)). The at least one processor may be configured to perform the various operations described herein when executing instructions stored on a computer-readable storage device (e.g., a hard drives, random access memory (RAM)). The computing device may include or be communicatively coupled to at least one output device, such as a display device.

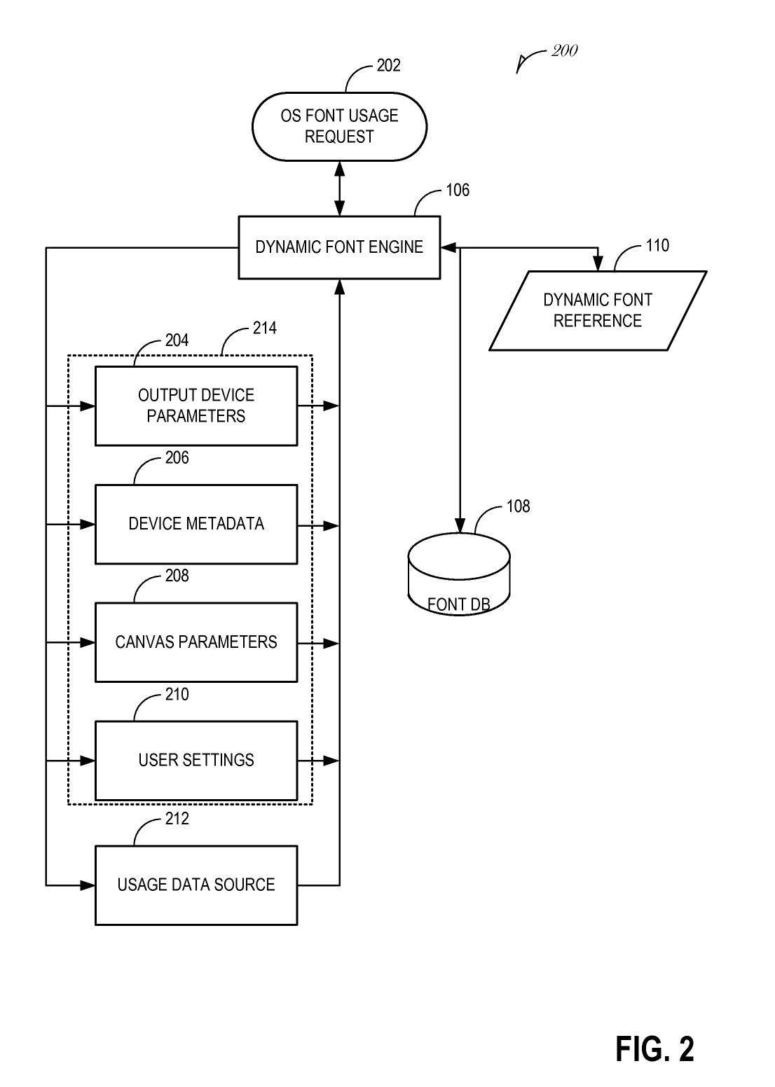

In various examples, the components of FIG. 1—and components illustrated in FIGS. 2, 3, and 5—are not limited to a single computing device, but may be spread across additional computing devices. Similarly, the operations discussed with respect to an individual component may be performed by a different component (e.g., components may be combined or separated) without departing from the scope of the present disclosure.

In various examples, the font database 108 stores one or more font files. In an example, the font database 108 is an organized collection of the font files. For example, the font database 108 may be organized in folder structure with each font file within one or more folders. In various examples, the font database 108 is flat file database identifying the location of the font files. In other examples, the font database 108 is maintained as a relational or non-relational database. The font database 108 may be queried or accessed with one or more pieces of identifying information to retrieve a font file.

In an example a font file is identified by a font face (e.g., “Times New Roman”). The font file may include data representing the shape of each printable character (e.g., ‘A’, ‘B’, ‘C’, etc.). In an example, the data may be a Bézier curve or glyph. In some examples, a font file may include a collection of data for weight variations (e.g., Heavy, Medium, etc.,) of the font face. In some examples, a font face may have more than one font file for the variations. Instead of, or in addition to the curves, a font file may include bitmaps for the characters at different sizes and variations of the font face.

In some examples a font is capable of being modified without separate collections of files. For example, instead of having a “heavy” version of the font and a “light” version of the font, a weight value (e.g., from 0-1) may be applied to the font to achieve the same effect. For example, a 0.5 value may correspond to a “regular” weight of the font.

Traditionally, the OS font system 104 is responsible for returning an instance of a font to render text for an application. For example, consider an application that identifies a font by name and size of the font face to use for a piece of text. At runtime, the OS font system 104 may query the font database 108 for the font file for the font name. The OS font system 104 may then output a font reference to the font face associated with the font name, which is ultimately used by a graphics engine to render the text for the application at the specified size.

With reference back to FIG. 1, the font usage request 102 may be an application programming interface (API) call. In an example, an API is a set of defined functions calls to ease application development. For example, an OS may provide an API to application developers that provides basic low level functions such as object or text rendering. An API call may be identified by a name and include zero or more arguments or parameters. During execution, the function may return a data object, a reference to a data object, or value.

For example, in the context of the font usage request 102, a description of API call may look like:

*DynamicFontReference retrieveUsageFont (string fontusage, int size)

Continuing the above example, a user may place the following in his/her application to make use of the font reference returned by the API call to output the text “Hello World”:

PrintText (retrieveUsageFont (System_Font, 12), “Hello World”);

As described, the two example arguments of the API call are a name for the font usage and a requested font size. While described as an integer, font size may also be specified in qualitative terms (e.g., small short footnote, medium size headline, large paragraph text). Additionally, the API call may return a reference to a virtual font object. In an example, the font usage is a string that describes the usage of text to be rendered. For example, the font usage description may be a document font, system user interface font, digital clock font, small label font, among others. In an example the font usage description is the name of a font face. In various examples available values for the font usage parameter are predefined as part of the dynamic font engine 106 or other component of the operating system.

In various examples, a developer does not need to specify a preferred size. Similarly, the API call may include additional optional arguments in the call such as a language preference, preferred regular text size, preferred style, and a preferred text weight (e.g., regular, light, medium, heavy). Additionally, the labels of the returned value, the function call, and parameters of the function call are for illustration purposes and other labels may be used without departing from the scope of this disclosure.

In various examples, during execution of application, the font usage request 102 is initially handled by the OS font system 104, at which point a request is made to the dynamic font engine 106 to determine one or more appropriate font characteristics for the specified font usage. Further details of how the dynamic font engine 106 determines the appropriate font characteristic(s) is described with respect to FIG. 2.

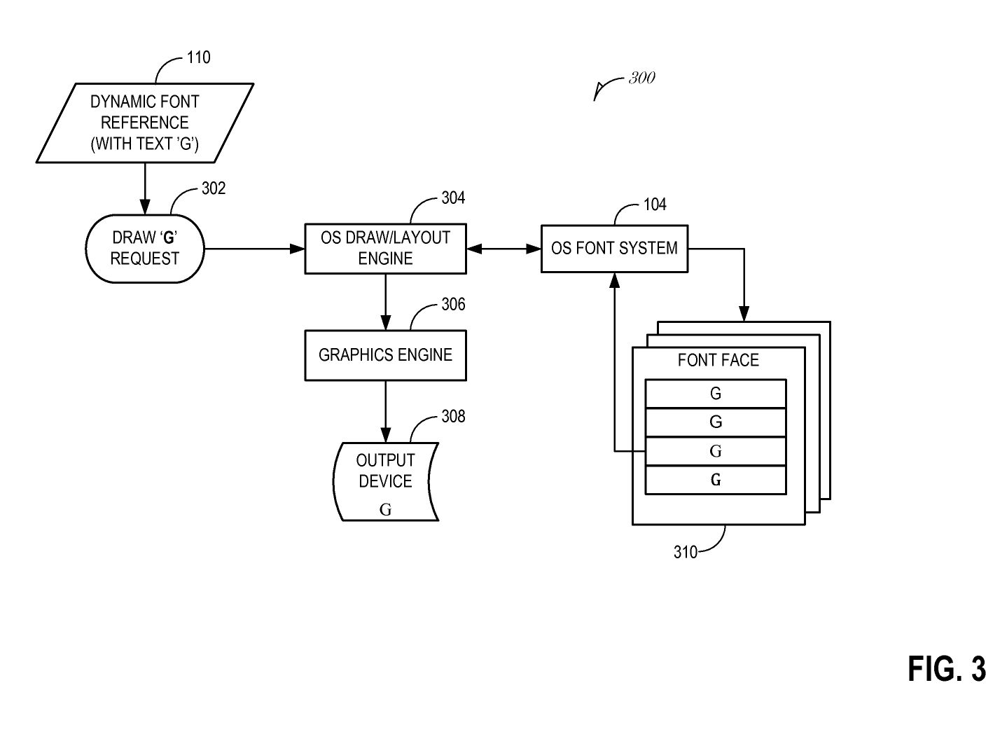

In an example, the application developer uses the DynamicFontReference object (illustrated as dynamic font reference 110) in portions of his/her application that call for rendering text. In other words the dynamic font reference may be considered the virtual font. Then, during execution of the application, the ultimate decision of what font characteristics (face, style, spacing, etc.) to use may be determined and the text rendered. More details of the rendering process are described with reference to FIG. 3.

FIG. 2 illustrates a schematic diagram 200 of a determination of the dynamic font reference 110. Schematic diagram 200 includes an OS font usage request 202, the dynamic font engine 106, the font database 108, the dynamic font reference 110, output device parameters 204, device metadata 206, canvas parameters 208, user settings 210, and a usage data source 212. In various examples, the output device parameters 204, the device metadata 206, the canvas parameters 208, and the user settings 210 may be collectively referred to as a display context 214. The grouping of the display context described below is only an example of possible groupings of the data. Other examples may group the data differently without departing from the scope of this disclosure. For example, the output device parameters 204 may be considered part of the canvas parameters 208.

In various examples, the OS font usage request 202 is received at the dynamic font engine 106 via the OS font system 104 (not illustrated in FIG. 2). In an example, the OS font usage request 202 include the parameters specified by an application developer in the API call (e.g., the font usage request 102). In an example, the font usage request 102 is passed through to the dynamic font engine 106 by the OS font system 104 instead of generating the OS font usage request 202.

In various examples, the dynamic font engine 106 processes the OS font usage request 202 to determine one or more fonts that fit the particular usage specified in the request. The dynamic font engine 106 may query OS subsystems to help make this determination. For example, the dynamic font engine 106 may query one or more OS subsystems of the computing device to retrieve the display context for the request. In an example, some or all of the data in the display context is retrieved from data sources external to the computing device. In an example, some or all of the data in the display context is retrieved from sensors including, but not limited to, an accelerometer, a light sensor, proximity sensor, GPS, orientation sensor, of the computing device.

In an example, the output device parameters 204 are associated with an output device of the computing device. Output devices may include, but are not limited to, a monitor screen, a printer, a laser-etching machine. In various example, an output device is an emulation of another device. In an example, the output device parameters may include, but are not limited to, size, resolution, pixel size/density, output surface (e.g., LED, LCD, electronic paper), curvature of a display, backlighting characteristics, front lighting characteristics, and contrast capabilities. In an example, the output device parameters 204 are associated with an output device that is not directly part of the computing device. For example, if the computing device is a personal computer, the output device may be connected to the computing device via a display adapter. In an example, the output device parameters 204 are stored on the computing device (e.g., as part of a display driver, device preferences, etc.). In an example, a graphics subsystem of the OS may be queried to retrieve the output device parameters 204.

In an example, the device metadata 206 is device associated with the computing device itself. For example, the device metadata 206 may include but is not limited to how a device is used such as a typical reading distance, a typical reading angle, operating system of the computing device, if the screen of the computing device is being shown on an external display (e.g., screen sharing).

In an example, the canvas parameters 208 relate to a current use of the output device and computing device. For example, the canvas parameters 208 may include, but are not limited to, an orientation of the computing device, a current background color of the display, current ambient lighting conditions, brightness of the output device, contrast of the output device, where in the output device the text is to be rendered (e.g., if a screen is curved is the text in the center of the curve?), and a color scheme of the output device.

In various examples, the user settings 210 are associated with preferences of a user of the computing device. For example, the user settings 210 may include a requested text size, language preferences, a preferred regular text size, and a preferred regular text weight. Thus, there may be settings of the display context outside of those specified in the application.

In various examples, the usage data source 212 stores relationships between the display context 214 and a set of font faces of for a given usage. In other words, for a given identified font usage (e.g., a digital clock font), the usage data source 212 may identify a set of font faces to use for a given display context. Thus, for each usage there may be numerous sets of fonts depending on the display context. In addition to a font face, the usage data source 212 may identify typographical adjustments/font characteristics (e.g., weight, style, size, shape) for a given usage and display context. For example, a different shape for a character may be retrieved depending on the optical size.

In an example the usage data source 212 is organized as a table or database. In various example, global pieces of information may be utilized by the dynamic font engine 106 beyond those illustrated in FIG. 2 to determine an appropriate font. For example, visual acuity may also be utilized to determine the set of font faces for a given usage.

In various example, more than one output device may have text being rendered. For example, a mobile device may be streaming content to an external TV. These output devices may have different properties such as pixel density, typical viewing/reading distances, etc. In such instances there may be two different sets of font faces and font characteristics retrieved for a given rendering of text, one for each output device.

FIG. 3 illustrates is a schematic drawing 300 illustrating rendering text using a dynamic font reference, according to an example embodiment. The schematic drawing 300 illustrates the dynamic font reference 110, a draw request 302, an OS drawing/layout engine 304, the OS font system 104, a graphics engine 306, an output device 308, and a font face 310.

In various examples, when an application is executing and a request is made to render text using a virtual font, the process illustrated in FIG. 3 may be utilized. For example, during execution there may be a function call such as “DisplayText (‘G’, SystemUI).” This call may signal to the OS of the computing device that the character ‘G’ is to be outputted on an output device, which is represented as the output device 308, using the virtual font identified as “SystemUI.” In an example, “SystemUI Font” is a reference to a dynamic font object that was returned using a previous API call. In an example, the “DisplayText” function may be configured to retrieve the dynamic font object during runtime. For example, the call may look like:

DisplayText (‘G’, retrieveUsageFont(SystemUI))

In an example, during execution, the DisplayText call may generate the draw request 302 which may be initially handled by the OS draw/layout engine 304. In an example the OS draw/layout engine 304 facilitates the retrieval of the appropriate font face according to the dynamic font reference 110 and passing the font face to the graphics engine 306. For example, upon receiving the draw request 302, the OS draw/layout engine 304 may pass the request to the OS font system 104.

As discussed above, the dynamic font reference 110 may identify the appropriate font for the current display context. Thus, the OS font system 104 may retrieve the identified font file. In some examples, there may be more than one font that has been identified as appropriate for a given display context. In such instances, a font face may be selected based on a priority level (e.g., font X has a higher priority than font Y) according to how well the retrieve fonts match the output for a given display context as determined by the dynamic font engine 106. In cases in which the dynamic font is first used during runtime, as discussed above, the OS font system 104 may initiate a request to the dynamic font engine 106 (not illustrated in FIG. 3) to determine the appropriate font.

In various examples, given the retrieved font face, the graphics engine 306 may output the text identified in the draw request 302 using the font face and font characteristics identified by the dynamic font reference 110.

In various examples, the dynamic font engine may modify aspects of a font before any output. For example, stroke weight (bold-light), design width (narrowness), and glyph variants (shape) may all be modified. With respect to a glyph, consider the character ‘g’. There may be a ‘g’ with e a single loop with a defender tail or a double loop with one ascending and the other descending. Furthermore, the outline (interpolation, dilation) or algorithmic modifications (mathematical or based on data parameters) may be used to modify a glyph of a font. Other variations may also be used to aid legibility or distinctiveness. For example, layout spacing, which may be tracking, or kerning, and line spacing. such as tall leading, short leading, double leading etc., may be modified by the dynamic font engine before text is output. The above modifications may be based on data stored the usage data source described above. The modifications may result in retrieving a different font weight (e.g. “regular” vs “light”) or applying a weight value to a characteristic of the font (e.g., applying a 0.5 weight, spacing, width, outline, etc.).

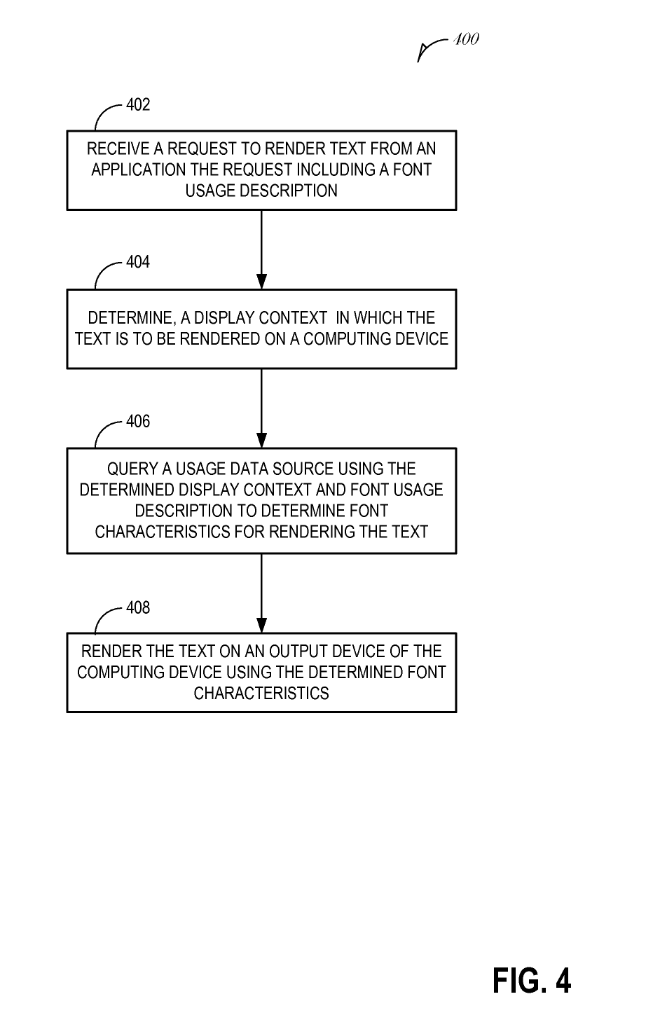

FIG. 4 is a flow chart illustrating a method 400, in accordance with an example embodiment, to render text. The method 400 may be performed by any of the modules, logic, or components described herein. In an example, the method 400 includes; at operation 402, receiving a request from an application to render text, the request including a font usage description; at operation 404, determining a display context in which the text is to be rendered on a computing device; at operation 406, querying a usage data source using the determined display context and font usage description to determine font characteristics for rendering the text; and at operation 408, rendering the text on an output device of the computing device using the determined font characteristics.

In an example, at operation 402, the request is processed by an operating system of the computing device. For example, during execution of the application a call may be made from the application to a drawing/layout engine executing on the same computing device as the application. In various examples, the font usage description may be a string that identifies a use case or may be a preferred font face. The font usage description may also include a preferred font size and weighting. The font size and weighting may be specified in qualitative (e.g., small, medium, or large) or quantitative (e.g., 10, 12, 14) terms.

In various examples, at operation 404, the display context may be determined by querying subsystems of the computing device. For example, sensors of the computing device may determine the orientation of the output device and ambient light level surrounding the computing device. Other data included in the display context may be characteristics of the output device of the computing device such as resolution and pixel density. Still further data may include information on how the computing device is typically used and user preferences related such as default text size and weighting. The user of the computing device may be different than the application developer, and therefore have different preferences. In other words a preferred text size in the usage request may be different that a text size preferred by a user. Subsystems may also be queried to determine information currently being displayed on the computing device such as a background color. In an example, operation 404 may be repeated for each output device that is to render text (e.g., in the case of text streaming or mirroring).

In various examples, at operation 406, the usage data source may determine a set of one or more font characteristics for rendering the text. For example, the usage data source may correlate the display context with a set of font faces, sizes, etc., that result in an aesthetically pleasing rendering of text (as determined by an OS designer, for example). In an example, aesthetics may modeled by a weighting algorithm that includes values for different combinations of factors. For example, the usage data source may store values ranging from 0 to 1 for each font size for a given output device size, for a given font color given a background color, etc. The values may be summed to arrive at an overall value and the highest value may be used to determine the characteristics for rendering the text.

In various examples, if there are multiple characteristics (e.g., font face) correlated, a determination may be made as to whether one of the correlated characteristics matches a preferred characteristic in the usage description. If so, the matching characteristic may be used. In other words, if the developer has indicated a preferred font size of 12 and the query of the usage data source indicates either 10 or 12 would be acceptable, font size 12 may be used. In an example, if a developer specified font face does not have the character indicated to be rendered a different font face may be selected for the display context.

In various examples, different characters in a given string of text may have different font characteristics for a given display context. For example, one character might have a different weight than a second character within the same string of text.

In various examples, at operation 408, the text is rendered with the determined font characteristics. For example, a font file may be retrieved from a font database that includes data identifying how to render the text. In various examples, the shape of the individual characters may be modified before rendering. In various examples, the spacing between the individual characters or between lines of text may be modified before rendering.

### Example Computer System

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

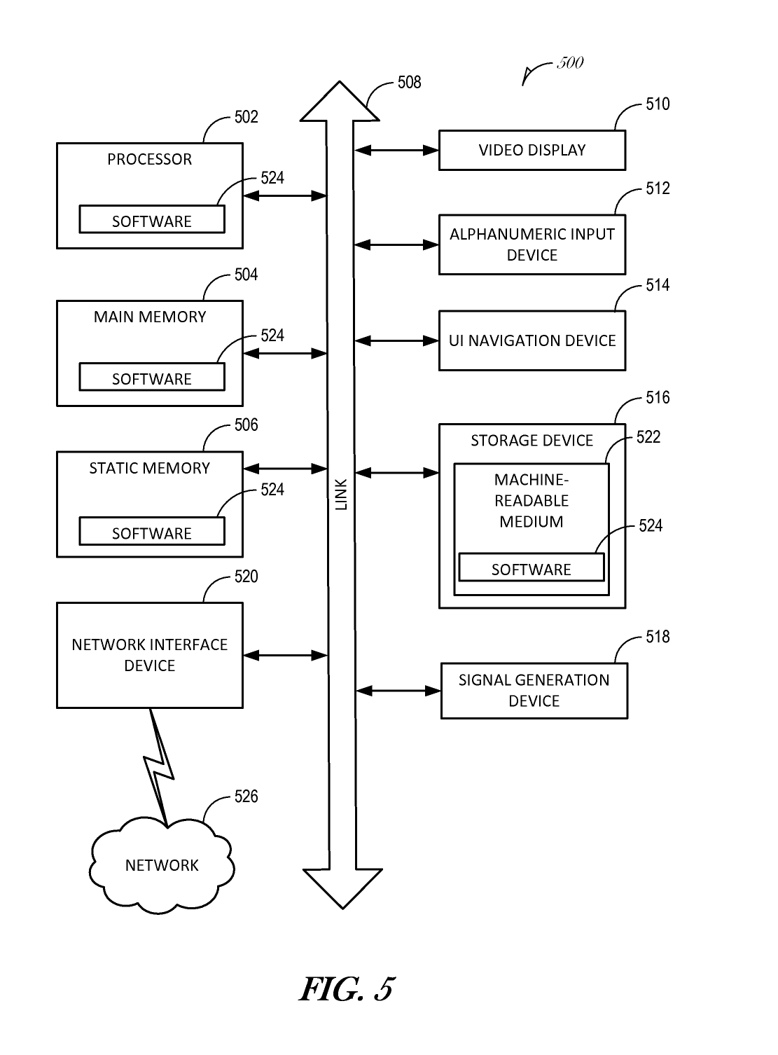

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the at least one processor 502 during execution thereof by the computer system 500, with the main memory 504, static memory 506, and the at least one processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A method comprising:
receiving a request to render text from an application executing on at least one processor of a computing device, the request including a font usage description;
determining, using the at least one processor, a display context in which the text is to be rendered on an output device communicatively coupled to the computing device;
querying, using the at least one processor, a usage data source using the determined display context and font usage description to determine font characteristics for rendering the text; and
rendering the text on the output device communicatively coupled to the computing device using the determined font characteristics.

2. The method of claim 1, wherein determining at least one characteristic of the display context in which the text is to be rendered comprises:
retrieving data from at least one sensor of the computing device.

3. The method of claim 2, wherein retrieving data from at least one sensor of the computing device:
retrieving an orientation of the output device communicatively coupled to the computing device.

4. The method of claim 1, wherein determining at least one characteristic of the display context in which the text is to be rendered comprises:
determining a pixel density of the output device communicatively coupled to the computing device.

5. The method of claim 1, wherein determining at least one characteristic of the display context in which the text is to be rendered comprises:
determining a background color of the output device communicatively coupled to the computing device.

6. The method of claim 1, wherein the request to render text includes a font size and wherein determining font characteristics for rendering the text includes selecting a different font size than the font size of the request.

7. The method of claim 1, wherein the request to render text includes a font face.

8. The method of claim 7, and wherein determining the font characteristic comprises:
modifying a glyph of the font face.

9. A non-transitory computer-readable medium with instructions stored thereon, which when executed by at least one processor of a computing device, configure the at least one processor to perform operations comprising:
receiving a request to render text from an application, the request including a font usage description;
determining a display context in which the text is to be rendered on a output device communicatively coupled to the computing device;
querying a usage data source using the determined display context and font usage description to determine font characteristics for rendering the text; and
rendering the text on the output device of the computing device using the determined font characteristics.

10. The non-transitory computer-readable medium of claim 9, wherein determining at least one characteristic of the display context in which the text is to be rendered comprises:
retrieving data from at least one sensor of the computing device.

11. The non-transitory computer-readable medium of claim 10, wherein retrieving data from at least one sensor of the computing device:
retrieving an orientation of the output device communicatively coupled to the computing device.

12. The non-transitory computer-readable medium of claim 9, wherein determining at least one characteristic of the display context in which the text is to be rendered comprises:
determining a pixel density of the output device communicatively coupled to the computing device.

13. The non-transitory computer-readable medium of claim 9, wherein determining at least one characteristic of the display context in which the text is to be rendered comprises:
determining a background color of the output device communicatively coupled to the computing device.

14. The non-transitory computer-readable medium of claim 9, wherein the request to render text includes a font size and wherein determining font characteristics for rendering the text includes selecting a different font size than the font size of the request.

15. A computing device comprising:
an output device;
a non-transitory computer-readable medium with instructions stored thereon; and
at least one processor, wherein the at least one processor is configured to execute the instructions to:
receive a request to render text, on the output device, from an application executing on the at least one processor, the request including a font usage description;
determine a display context in which the text is to be rendered on the output device;
query a usage data source using the determined display context and font usage description to determine font characteristics for rendering the text; and
rendering the text on the output device using the determined font characteristics.

16. The computing device of claim 15, further comprising:
at least one sensor; and
wherein to determine the display context in which the text is to be rendered on the output device, the at least one processor is configured to retrieve data from the at least one sensor.

17. The computing device of claim 16, wherein to retrieve data from the at least one sensor, the at least one processor is configured to retrieve an orientation of the output device.

18. The computing device of claim 15, wherein to determine the display context in which the text is to be rendered on the output device, the at least one processor is configured to determine a pixel density of the output device.

19. The computing device of claim 15, wherein to determine the display context in which the text is to be rendered on the output device, the at least one processor is configured to determine a background color of the output device.

20. The computing device of claim 15, wherein the request to render text includes a font size and wherein to determine the font characteristics for rendering the text the at least one processor is configured to select a different font size than the font size of the request.
